(19) United States
(12) Patent Application Publication
(10) Pub. No.: US 2024/0161040 A1
(43) Pub. Date: May 16, 2024

(54) METHOD FOR INTERACTIONS BETWEEN TRAFFIC AND TRANSPORTATION SYSTEMS BASED ON SDG FRAMEWORK

(71) Applicant: Research Institute of Highway, Ministry of Transport, Beijing (CN)

(72) Inventors: Xiaofei Liu, Beijing (CN); Dan Wang, Beijing (CN)

(21) Appl. No.: 18/418,516

(22) Filed: Jan. 22, 2024

(30) Foreign Application Priority Data
Dec. 25, 2023 (CN) 202311795378.0

(51) Int. Cl. G06Q 10/0637; G06F 17/16

(52) U.S. Cl. CPC G06Q 10/0637; G06F 17/16

(57) ABSTRACT

The present disclosure provides a method for interactions between traffic and transportation systems based on a sustainable development goal SDG framework. The method includes: step 1: extending and perfecting, through a Delphi method, sustainable transport indicators under an SDG framework; step 2: drawing first-order gaming and synergistic effect between traffic SDGs and synergy through a typological cross-impact matrix and in combination with a panel vector autoregressive model; step 3: parsing a multi-goal second-order interaction mechanism after probability coefficients are introduced, to determine a leverage point of a multi-goal system with maximum synergistic effect; and step 4: determining stability of the leverage point of the multi-goal system based on sensitivity analysis and sectoral analysis. According to the present disclosure, a qualitative framework and a cross-impact matrix are used to meticulously extract knowledge, and a data-driven method is used to explore second-order action between goals and search the leverage point. In addition, a Delphi method is used to form a management method for sustainable development of transport.

### TECHNICAL FIELD

The present disclosure belongs to the technical field of transportation, and in particular to a method for interactions between traffic and transportation systems based on an SDG framework and a leverage point strategy.

### BACKGROUND

It is extremely urgent to implement various tasks specified in the 2030 United Nations Sustainable Development Goal (Sustainable Development Goal, SDG) and the Paris Agreement on Climate Change. It is essential for accelerating synergistic progress of multiple goals and specific goals. The Second United Nations Global Sustainable Transport Conference was held in Beijing in 2021, highlighted importance of sustainable transport in implementing 2030 Agenda for Sustainable Development and the Paris Agreement on Climate Change.

Solutions to completely implement sustainable transport are actively sought for transport systems. Goals of the sustainable transport are to implement an apparently common practice, improve safety, reduce impact of environment and climate, and improve resilience and efficiency, which are at the heart of sustainable development. Challenges for traffic and transportation systems are how to collaboratively promote implementation of a plurality of sustainable goals to the maximum extent under supports of available resources. During supporting implementation of United Nations sustainable development goals, integration and cross nature of the sustainable transport are evident. For example, an SDG 9 of building accessible transport networks greatly contributes to an SDG 1 goal of reducing poverty. However, traffic accidents are increased while roads are increased. Therefore, there is slight inhibiting effect on an SDG 3 goal of reducing traffic fatalities. Synergistic development of a sustainable transport system including a plurality of development goals can only be implemented by fully understanding interconnections between the sustainable transport and SDGs and between the sustainable transport of a plurality of goals, resolving trade-offs through the interconnections, and benefiting from potential synergies.

For example, the patent application 202210711702.5 discloses a multi-goal decision-making method for sustainable maintenance of a large-scale pavement net. The method includes: performing, by performing binary transformation based on a decision tree, a maintenance decision-making at a unit level for a road section of a regional pavement network; determining a sustainable goal value at the unit level of the road section based on a maintenance decision-making result at the unit level of the road section and spatial and a temporal distribution feature of a traffic flow; based on a principle of dimensionality reduction in decision-marking space, combining large-scale road section units into small-scale maintenance units, and calculating the sustainable target value at a network level for performing maintenance decision-marking at the network level; solving an optimization model for combination of sustainable goals at the network level through a multi-goal evolutionary algorithm, and preparing a strategy set having a plurality of potential feasible solutions at the network level; and determining a final feasible solution through an interactive method, and linking a decision result at the network level to the unit level of the road section based on a decision space transformation principle. According to the patent application, while sustainable multi-goal decision-making for the large-scale pavement network is implemented, the decision-making result at the network level and the decision-making result at the unit level of the road section are coordinated.

To enable the sustainable transport to have an operational form, many research institutes and scholars acknowledge that establishment of an indicator system is indispensable. However, in the field of transportation, there are fewer studies on assessment and solutions for the sustainable transport under an SDG framework. A new thought of exploring theoretical research on the sustainable transport is to introduce the SDG framework. Because sustainability is fundamentally a normative assertion about trade-offs between values, how society chooses specific details from the trade-offs is at the heart of a sustainability issue. Therefore, the widely accepted SDG framework is selected to parse interactions for sustainable transport, and is more likely to be recognized by international communities. In addition, indicators comprehensively cover sustainable social, economic, and environmental dimensions.

At present, no single methodology, category, or research tradition (that is, quantitative or qualitative) can be considered as a most appropriate method for analyzing interactions between SDGs. A quantitative method (that is, statistics, simulation, and other quantitative methods) is most commonly used in a scientific context. Methods such as interview debates and expert knowledge are particularly useful for obtaining information on effect. In addition, interdisciplinary collaboration is implemented. At present, more mainstream analytical methods are as follows. Firstly, Nilsson, from the Stockholm Environment Institute proposes seven types of interactions between SDG goals, ranging from “(−3) cancellation” to “(+3) inseparability”, which is widely accepted by academics. Subsequently, Weitz creates a cross-matrix through the seven scoring methods and expert knowledge, to obtain goals with maximum impact and minimum impact during implementation of the sustainable development goals in Sweden, and areas in which strong positive and negative associations are located. Secondly, Pradhan proposes a threshold for determining game and synergy between sustainable development goals. To be specific, if an absolute value of a correlation coefficient is greater than 0.6, it is considered as the synergy or game, which is widely accepted. Some scholars decrease the threshold to 0.5. Subsequently, the Pradhan team develops a set of models to research a leverage point of an SDG system, and establish a multiple feedback path between the SDGs and targets through assignment of weights. The leverage point perspective can be understood in terms of systemic change and sustainable transformation. A simple logic is to search a right lever and adjust the lever, until the system produces a better result.

A term “second-order action” exists in an existing methodology, which is to analyze effect of the synergy and gaming between the SDGs, that is, effect of one SDG goal on another SDG goal is implemented through a third goal. Some scholars have also questioned the second-order calculations based on the seven types of qualitative frameworks. For example, it is not clear whether interactions between “(+1) enablement” and “(−1) constraint” causes null effect, which is a problem for all calculations based on qualitative analysis.

### SUMMARY

In view of this, a first objective of the present disclosure is to provide a method for interactions between traffic and transportation systems based on a sustainable development goal SDG framework. In the method, qualitative analysis and quantitative analysis are performed in interactions between SDGs, to make up for each other's shortcomings. Therefore, analysis is accurate and reliable.

In the method, a qualitative framework and a cross-impact matrix are used to meticulously extract knowledge, and a data-driven method is used to explore second-order action between goals and search the leverage point. In addition, a Delphi method is used to obtain more consensual expert knowledge, and creatively applied to transport systems, to perform in-depth analysis on a multi-goal interaction mechanism of the sustainable transport, position a leverage point with maximum synergies, and form a management method for sustainable development of transport.

To achieve the above objective, the technical solution adopted by the present disclosure is:

A method for interactions between traffic and transportation systems based on a sustainable development goal SDG framework includes the following steps.

Step 1: Extend and perfect, through a Delphi method, sustainable transport indicators under an SDG framework, where
a sequence of occurrence and a lexical frequency of a developmental task are analyzed through the Delphi method, the sustainable transport indicators are in a one-to-one correspondence to 17 SDGs and indicators at a next level of the SDG framework, and the sustainable transport indicators, including quantitative indicators and qualitative indicators, are refined and constructed.

Step 2: Draw first-order gaming and synergistic effect between traffic SDGs and synergy through a typological cross-impact matrix and in combination with a panel vector autoregressive model, where the “first-order action” is defined as “direct effect of a goal A on a goal C; if the goal A has effect on a goal B, and the goal A has effect on the goal C and a goal D, effect of the goal A on the goal C and the goal D is the second-order action, an interaction between sustainable development goal systems are represented with knowledge of experts and stakeholders.

Step 2 specifically includes:

2.1: Analyze the Quantitative Indicators.

Within a range of the quantitative indicators, correlation is determined by performing related analysis on a non-parametric Spearman rank between goal pairs; synergy is defined: If the goal pairs have a significant positive correlation, with a correlation coefficient greater than 0.5, and have a significant negative correlation, with a correlation coefficient less than −0.5, it is considered that there is gaming; an interaction between goals is analyzed through the panel vector autoregressive model. A formula is as follows:

LnSDG_{p,t}ⁱ=β₀+β₁*LnSDG_{a,p,t-1}+β2*LnSDG_{b,p,t-1}+β₃*LnTFE_{p,t-1}+(cₚ+e_{p,t}) (1)

, where

p represents a province, and t represents year; SDG_{p,t}ⁱ represents a score of an SDG of an i^{th} of a province p in year t; SDG_{a,p,t-1} represents a score of an SDG a in a province p with a lag of one year, SDG_{b,p,t-1} represents a score of an SDG b in the province p with a lag of one year, and TFE_{p,t-1} represents a fiscal expenditure on transport in the province p with a lag of one year; cₚ represents fixed effect between provinces; e_{p,t} represents an error term. A logarithm of each variable is calculated, to eliminate impact of heteroscedasticity and different orders of magnitudes. In the formula, the lag of one year is selected, and regressions in this study exclude impact of autocorrelation and heteroscedasticity.

An SDG a and an SDG b are goals that have a highest number of significant correlations with other goals and that are obtained based on Spearman rank correlation analysis. Considering impact of a capital investment on development of transport infrastructure, a variable of local financial expenditure on transport is introduced. A dependent variable means a score of an SDG indicator other than an SDG a and an SDG b. Considering a variable that is not tested, a fixed effect model is used. In addition, because impact of income incentives, development of transport infrastructure, and transport investment become apparent after a period of time, one-year lag effect is introduced in an independent variable.

2.2: Analyze the Qualitative Indicators.

A cross-impact matrix is constructed in a manner of scoring by experts through a questionnaire, to organize and summarize knowledge about interactions between SDGs in traffic; and through a seven-score typology that specifically describes nature of the interactions between SDGs, analysis is performed from cancellation (−3), counteraction (−2), constraint (−1), and no significant interaction (0) during a negative interaction, to advancement (+1), reinforcement (+2), and inseparability (+3) of a positive interaction.

Further, in the cross-impact matrix, a sum of high rows indicates that a goal has great net positive effect on another goal, and a goal with the sum of high rows is regarded as a synergistic goal. A list of cross-impact matrices belonging to each expert is extracted from questionnaires submitted by the experts, a score of each expert on each pair of goals is superimposed, and the list of cross-impact matrices is obtained by averaging scores of all experts.

A scoring questionnaire of the interactions is sent to the experts, attached with graphic descriptions of basic knowledge about the SDG, each score is attached with explanatory annotation, and a first round of scoring is performed. A summary of the first round of scoring is fed back to the experts through the Delphi method, the experts are required to perform a second round of scoring, and finally, results of scoring are analyzed.

Step 3: Parse a multi-goal second-order interaction mechanism after probability coefficients are introduced, to determine a leverage point of a multi-goal system with maximum synergistic effect. Step 3 specifically includes:

Step (1): A cross-matrix diagram is visualized.

A network analysis diagram of a system network architecture SNA is used to reflect directions and degrees of interactions between goals in pairs in a thermodynamic matrix diagram, and a network diagram that there is an interaction with another key goal is extracted for subsequent second-order analysis.

Step (2): Second-order action between goals is analyzed based on probability, and a multi-goal downstream feedback path is captured.

The impact of A on C includes: 1: the direct impact of A on C (line 1); 2: impact of B on C after impact of A on B, that is, A has second-order impact on C (line 2). Concept of probability is introduced, to be specific, 6 scores represent 90% probability of impact, 2 scores represent 60% probability of impact, 1 score represents 30% probability of impact, and 0 scores represents 0% probability of impact.

Therefore, if probability of second-order impact of A on C is 60%*(−30%)=−18% and probability of first-order impact of A on C is +90%, a sum of the second-order impact of A on C and the first-order impact of A on C is (+90%)+(−18%)=+72%. It should be noted that the sum of the second-order impact of A on C and the first-order impact of A on C can exceed 100%.

A specific formula is as follows:
1: first-order impact (direct impact of A on C):
P_{A}C=probability value

For example, if the impact of A to C has 90% of positive impact, P_{Ac}=90%.
2: second-order impact (indirect impact of A on C through B):

P_{ABC}=P_{AB}×P_{BC}

For example, if probability of the impact of A on B is 60%, and probability of impact of B on C is −30%, P_{ABC}=60%×(−30%)=−18%.
3: overall impact (overall impact of A on C, including the first-order impact and the second-order impact).

P_{Total}=P_{AC}+P_{ABC}

If P_{AC}=90% and P_{ABC}=−18%, P_{Total}=90%+(−18%)=72%.

A goal (group) with a highest score, that is, the leverage point for the system, is obtained after sorting is re-performed.

An impact path between goals is captured, first-order action and the second-order action between goals are quantified and summed, to obtain a corresponding second-order impact matrix, and a high-priority goal group is obtained by sorting.

Step (3): An empirical test is performed, and comparative analysis is performed with previous quantitative analysis.

Generally, the leverage point is in a range of the quantitative indicators, that is, there is a support by quantitative data; if there is no support by quantitative data, a corresponding quantitative indicator needs to be established, and a data source is obtained by mining a database or by discounting an intermediate coefficient. Considering that there is a time lag that transport infrastructure exerts socio-economic benefits after construction, the corresponding quantitative indicator is substituted into a panel regression model with a time-lag coefficient, to analyze an interaction between goals, and validate the leverage point by comparison.

Step 4: Determine stability of the leverage point of the multi-goal system based on sensitivity analysis and sectoral analysis.

Three sensitivity analyses are performed to test what extent a result depends on settings of scores and probability coefficients in the multi-goal system, and a difference in sorting of priorities of sustainable development goals by different transport sectors is checked.

This step specifically includes:

Test 1: Considering settings of scores −3 to 3, strictly. There is ordinal data rather than continuous quantitative data. Therefore, during sensitivity analysis, when first-order impact of the cross-impact matrix is calculated, by replacing a simple summing manner of original scores, a score with a highest frequency of occurrence is taken as a score of a grid. Subsequently, scores of rows and columns of the matrix are sorted.

Test 2: The probability coefficients are adjusted by 10%, that is, a (−3) score is 100%, a (±2) score is 50%, a (±1) score is 20%, and a (0) score is 0%. In this test, different attempts may be made.

Test 3: in this test, results are divided, and knowledge of experts in sectors such as roads, rails, air, and water transportation is analyzed separately, and priority action focuses of different transport sectors under the SDG framework are compared.

Compared with the prior art, the present disclosure has the following beneficial effects:

According to the present disclosure, a qualitative framework and a cross-impact matrix are used to meticulously extract knowledge, and a data-driven method is used to explore second-order action between goals and search the leverage point. In addition, a Delphi method is used to obtain more consensual expert knowledge, and a game and synergy mechanism between a plurality of goals in sustainable transport is implemented through the SDG framework in the transport system. Because the sustainable transport has multiple goals in a plurality of dimensions, by analyzing the multi-goal interaction mechanism in the transport system, sustainable development can be accelerated based on the maximum synergy. In addition, a complete feedback path between goals of the sustainable transport is obtained through a comprehensive correlation between goals of the sustainable transport based on development tasks under the SDG framework, to implement the goals of the sustainable transport.

Furthermore, according to the interaction mechanism between goals in the present disclosure, a list of ranked goals and network may be obtained, to search a priority group of goals with stability under different development focuses, search a group of goals with leverage points having maximum synergistic benefits and minimum gaming effect. Therefore, analysis is accurate and reliable, development costs can be saved to the maximum extent, the development of the sustainable transport can be comprehensively promoted, and a management level of the development of the sustainable transport is improved.

### BRIEF DESCRIPTION OF THE DRAWINGS

FIG. 1 is a schematic diagram of first-order action and second-action according to an embodiment of the present disclosure;

FIG. 2 is a schematic diagram of a questionnaire according to an embodiment of the present disclosure;

FIG. 3 is a schematic diagram of steps of creating a cross-impact matrix according to an embodiment of the present disclosure;

FIG. 4 is a schematic diagram of a leverage point according to an embodiment of the present disclosure,

FIG. 5 is a schematic diagram of calculation of first-order action and second-action according to an embodiment of the present disclosure; and

FIG. 6 is a diagram showing a technical route of the present disclosure.

### DETAILED DESCRIPTION OF THE EMBODIMENTS

In order to make the objectives, technical solutions and advantages of the present disclosure clearer, the present disclosure will be further described in detail below with reference to the accompanying drawings and examples. Understandably, the specific embodiments described herein are merely intended to explain the present disclosure but not to limit the present disclosure.

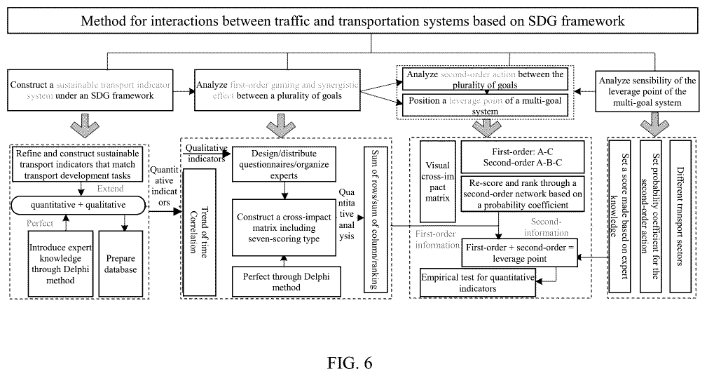

FIG. 6 is a diagram showing a technical route of the present disclosure. Firstly: Extend and perfect, through a Delphi method, sustainable transport indicators under an SDG framework. Secondly: Draw a first-order game between traffic SDGs and synergy through a typological cross-impact matrix and in combination with a panel vector autoregressive model. A cross-impact matrix is constructed in a manner of scoring by experts through a questionnaire, and through a seven-score typology that specifically describes nature of the interactions between SDGs, quantitative analysis and sorting are performed by summing rows and columns. Thirdly: After the probability coefficients are introduced, parse second-order action between multiple goals, to capture a multi-goal downstream feedback path. The second-order network illustrates systematic impact of the goals better than the first-order network, and provides a more complete information base. The goal (group) with a highest score obtained based on the second-order network is the leverage point of the system. Subsequently, empirical test is performed with the previous quantitative analysis. Fourthly: Determine stability of the leverage point of the multi-goal system based on sensitivity analysis and classification of different transport sector.

Specific Descriptions are as Follows:
The present disclosure provides a method for interactions between traffic and transportation systems based on a sustainable development goal SDG framework. The method includes:

Step 1: Extend and perfect, through a Delphi method, sustainable transport indicators under an SDG framework.

A sequence of occurrence and a lexical frequency of a developmental task in traffic are first analyzed through the Delphi method, the sustainable transport indicators are in a one-to-one correspondence to 17 SDGs and indicators at a next level of the SDG framework, and the sustainable transport indicators, including quantitative indicators and qualitative indicators, are refined and constructed.

To determine assessment standards for the sustainable transport and reflect the assessment standards in 231 SDG indicators, the Delphi method is useful. Especially Delphi method has features of integration of expert knowledge, anonymity of participants, and regular feedback. To ensure reliability of the result, experts are selected based on the following standards. Firstly, transport sectors having the experts cover sectors of road, railway, water transport, and air, and integrated sectors. Departments having the experts cover enterprises, universities and research institutes, administrative institutions, industry associations, and government departments. A specific design is as follows:

Step (1): Send a refined indicator system and background knowledge about SDG and sustainable transport to each expert, and ask the experts to evaluate the indicators separately and assign values ranging from 0 to 10, and provide open options, to encourage the experts to provide other related indicators. Step (2): Provide a summary of predictions by anonymous experts from the previous round, and ask the experts to make new scores and add indicators. Step (3): send new results to the experts based on indicators for screening and evaluation scores, to encourage the experts to revise the previous answers. Step (4): analyze to obtain a final indicator system. It is ensured that the sustainable transport indicator system is reliable and valid, and reflects awareness of stakeholders.

Step 2: Draw first-order gaming and synergistic effect between traffic SDGs and synergy through a typological cross-impact matrix and in combination with a panel vector autoregressive model.

The “first-order action” is defined as “direct effect of a goal A on a goal C; if the goal A has effect on a goal B, and the goal A has effect on the goal C and a goal D, effect of the goal A on the goal C and the goal D is the second-order action, as shown in FIG. 1. The quantitative method is suitable for research on a well-structured system, but such method is sufficient to analyze a system with a large amount of human components. Therefore, knowledge of experts and stakeholders is used to represent interactions between the SDG systems.

2.1: Analyze the Quantitative Indicators.

Considering the indirect effect between the indicators and a degree of quantifiability, on the one hand, the most related possible data sources for the indicators need to be extracted from expert opinions while the design is performed through the Delphi method. On the other hand, possible data sources are provided through coefficient transformation (for example, based on statistical data, a coefficient for an interaction between an SDG 1 of zero poverty and an SDG 9 of accessibility to a road network, uncertainty of indirect effect needs to be strongly controlled through examination of fitting coefficients).

Within the range of the quantitative indicators, to gain a preliminary understanding of two-way interactions between the goals, quantification is performed through a panel vector autoregressive model, to observe a causal relationship between different goals and a trend of time. Correlation is determined by performing related analysis on a non-parametric Spearman rank between goal pairs. Synergy is defined: if the goal pairs have a significant positive correlation, with a correlation coefficient greater than 0.5, and have a significant negative correlation, with a correlation coefficient less than −0.5, it is considered that there is gaming.

An interaction between goals is analyzed through the panel vector autoregressive model. A formula is as follows: where

LnSDG_{p,t}ⁱ=β₀+β₁*LnSDG_{a,p,t-1}+β2*LnSDG_{b,p,t-1}+β₃*LnTFE_{p,t-1}+(cₚ+e_{p,t})

p represents a province, and t represents year; SDG_{p,t}ⁱ represents a score of an SDG of an i^{th} of a province p in year t, SDG_{a,p,t-1} represents a score of an SDG a in a province p with a lag of one year, and SDG_{b,p,t-1} represents a score of an SDG b in the province p with a lag of one year. TFE_{p,t-1} represents a fiscal expenditure on transport in the province p with a lag of one year; cₚ represents fixed effect between provinces; e_{p,t} represents an error term. A logarithm of each variable is calculated, to eliminate impact of heteroscedasticity and different orders of magnitudes. In the formula, the lag of one year is selected, and regressions in this study exclude impact of autocorrelation and heteroskedasticity.

The SDG a and the SDG b are goals that have a highest number of significant correlations with other goals and that are obtained based on Spearman rank correlation analysis. Considering impact of a capital investment on development of transport infrastructure, a variable of local financial expenditure on transport is introduced. A dependent variable means a score of an SDG indicator other than the SDG a and the SDG b. Considering a variable that is not tested, a fixed effect model is used. In addition, because impact of income incentives, development of transport infrastructure, and transport investment become apparent after a period of time, one-year lag effect is introduced in an independent variable.

2.2: Analyze the Qualitative Indicators.

The natural sciences have a significant advantage in quantitative analysis. However, the research object of this project, the SDG system, is inextricably linked to value choices of the stakeholders. Therefore, in this project, key information needs to be extracted through qualitative analysis. Indicators for the qualitative analysis are more than indicators for the quantitative analysis, and the indicators for the qualitative analysis include the indicators for the quantitative analysis.

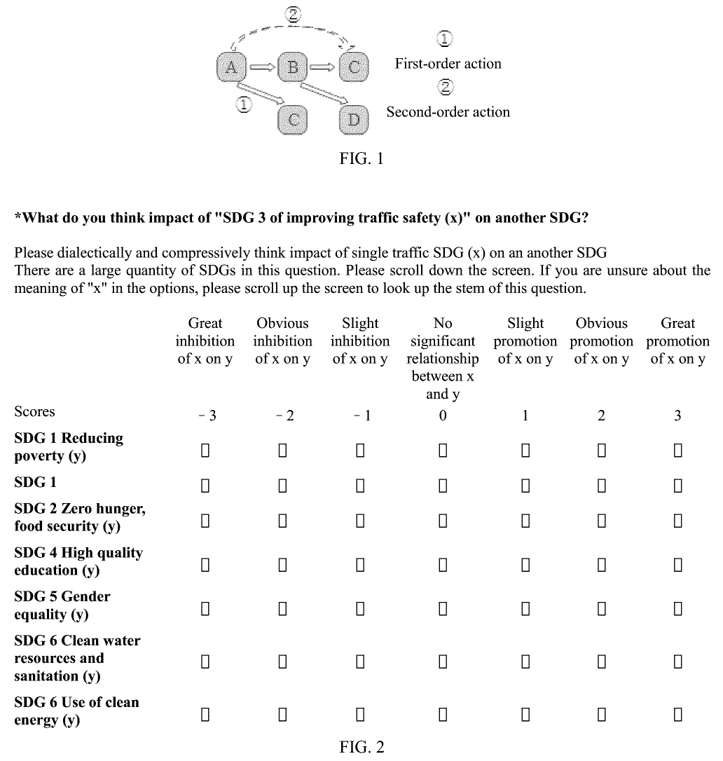

Firstly, a cross-impact matrix is constructed in a manner of scoring by experts through a questionnaire, to organize and summarize knowledge about interactions between SDGs in traffic. To determine scores of the interactions, it is proposed to use a seven-score typology that specifically describes nature of the interactions between SDGs, extending beyond a common but oversimplified dichotomy for accepting or rejecting a synergy versus gaming in preliminary research (that is, a synergistic interaction or gaming interaction is determined by determining whether the correlation coefficient is greater than 0.5). Analysis is performed from cancellation (−3), counteraction (−2), constraint (−1), and no significant interaction (0) during a negative interaction, to advancement (+1), reinforcement (+2), and inseparability (+3) of a positive interaction. Because the interaction between goals includes a degree and a direction, an express in a term of “effect of x on y” needs to be used in the questionnaire. For an example of a questionnaire of the preliminary design, refer to FIG. 2.

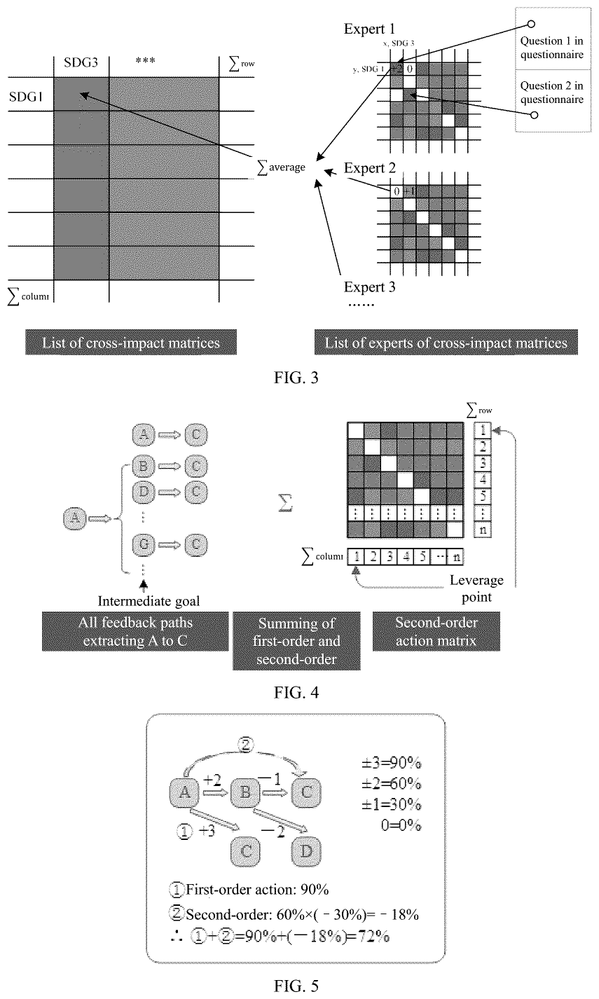

In the cross-impact matrix, a sum of high rows indicates that a goal has great net positive effect on another goal, and a goal with the sum of high rows is regarded as a synergistic goal. Therefore, other goals are more easy to implement. A sum of high columns indicates that a goal is greatly positively affected by another goal, with low control on independence or progress. For steps of creating a cross-impact matrix, refer to FIG. 3.

A list of cross-impact matrices belonging to each expert is extracted from questionnaires submitted by the experts, a score of each expert on each pair of goals is superimposed, and the list of cross-impact matrices is obtained by averaging scores of all experts.

The cross-impact scoring questionnaire is sent to the experts (a sample size is between 60 and 100), attached with graphic descriptions of basic knowledge about the SDG, each score is attached with explanatory annotation, to encourage the experts to dialectically think positive and negative impact between the goals (for example, “an SDG 11 of establishing a comfortable and convenient transport service” significantly promotes students in remote regions to accept high-quality education (SDG 4), and provides convenience for women to seek outside employment (SDG 5), but this may result in more energy consumption and carbon emissions (SDG 13)). A summary of the first round of scoring is fed back to the experts through the Delphi method, the experts are required to perform a second round of scoring, and finally, results of scoring are analyzed.

It must be acknowledged that the method for analyzing interactions between specific SDGs is strictly performed from bottom to up, and assessments on interactions between all goals depend on validity of the expert knowledge, and any such assessments are contentious.

Step 3: Parse a multi-goal second-order interaction mechanism after probability coefficients are introduced, to determine a leverage point of a multi-goal system with maximum synergistic effect.

The cross-impact matrix summarizes direct impact of a goal on another goal and determines whether the goal is directly affected by the another goal, that is, the first-order action. However, in the real world, multiple impact of the SDG system cannot be ignored, and the complex feedback path needs to be included in the research.

Step (1): A cross-matrix diagram is visualized. A network analysis diagram of a system network architecture SNA is used to reflect directions and degrees of interactions between goals in pairs in a thermodynamic matrix diagram, and a network diagram that there is an interaction with another key goal is extracted for subsequent second-order analysis. This visualization is more conducive to providing decision makers with information that can be quickly understood, especially relationship pairs of great facilitation and great inhibition.

Step (2): Second-order action between goals is analyzed based on probability, and a multi-goal downstream feedback path is captured. For a concept diagram, refer to FIG. 5. The impact of A on C includes: 1: the direct impact of A on C (line 1); 2: impact of B on C after impact of A on B, that is, A has second-order impact on C (line 2). Concept of probability is introduced, to be specific, 6 scores represent 90% probability of impact, 2 scores represent 60% probability of impact, 1 score represents 30% probability of impact, and 0 scores represent 0% probability of impact. An advantage of introducing the probability coefficient is to provide a good interpretation of the extent of second-order action. Therefore, if probability of second-order impact of A on C is 60%*(−30%)=−18% and probability of first-order impact of A on C is +90%, a sum of the second-order impact of A on C and the first-order impact of A on C is (+90%)+(−18%)=+72%.

A specific formula is as follows:
first-order impact (direct impact of A on C):
P_{AC}=probability value,
for example, if the impact of A to C has 90% of positive impact, P_{AC}=90%.
second-order impact (indirect impact of A on C through B):

P_{ABC}=P_{AB}×P_{BC}
for example, if probability of the impact of A on B is 60%, and probability of impact of B on C is −30%, P_{ABC}=60%×(−30%)=−18%.
overall impact (overall impact of A on C, including the first-order impact and the second-order impact); and

P_{Total}=P_{AC}+P_{ABC}

if P_{AC}=90% and P_{ABC}=−18%, P_{Total}=90%+(−18%)=72%;

It should be noted that the sum of the second-order impact of A on C and the first-order impact of A on C can exceed 100%, and Certainly, a magnitude of the probability coefficient affects final ranking of priorities of the goals. Therefore, the probability coefficient is reset and analyzed during sensitivity analysis. The second-order network illustrates systematic impact of the goals better than the first-order network, and provides a more complete information base. A goal (group) with a highest score, that is, the leverage point for the system, is obtained after sorting is re-performed (refer to FIG. 4).

An impact path between goals is captured, first-order action and the second-order action between goals are quantified and summed, to obtain a corresponding second-order impact matrix, and a high-priority goal group is obtained by sorting.

As shown in FIG. 5, the impact of A on C includes: 1: the direct impact of A on C (line 1); 2: impact of B on C after impact of A on B, that is, A has second-order impact on C (line 2). It is assumed that in the scores of the experts, 3 scores represent 90% probability of impact, 2 scores represent 60% probability of impact, 1 score represents 30% probability of impact, and 0 scores represents 0% probability of impact. Therefore, if probability of second-order impact of A on C is 60%*(−30%)=−18% and probability of first-order impact of A on C is +90%, a sum of the second-order impact of A on C and the first-order impact of A on C is (+90%)+(−18%)=+72%.

Step (3): An empirical test is performed, and comparative analysis is performed with previous quantitative analysis. Generally, the leverage point is in a range of the quantitative indicators, that is, there is a support by quantitative data; if there is no support by quantitative data, a corresponding quantitative indicator needs to be established, and a data source is obtained by mining a database or by discounting an intermediate coefficient. Considering that there is a time lag that transport infrastructure exerts socio-economic benefits after construction, the corresponding quantitative indicator is substituted into a panel regression model with a time-lag coefficient, to analyze an interaction between goals, and validate the leverage point by comparison.

Step 4: Determine stability of the leverage point of the multi-goal system based on sensitivity analysis and sectoral analysis.

Three sensitivity analyses are performed to test what extent a result depends on settings of scores and probability coefficients in the multi-goal system, and a difference in sorting of priorities of sustainable development goals by different transport sectors is checked.

Test 1: Considering settings of scores −3 to 3, score data is strictly ordinal data rather than continuous quantitative data. Therefore, during sensitivity analysis, when first-order impact of the cross-impact matrix is calculated, by replacing a simple summing manner of original scores, a score with a highest frequency of occurrence is taken as a score of a grid. Subsequently, scores of rows and columns of the matrix are sorted. The analysis on the interactions reflects a principle of “the minority is subordinate to the majority” of expert knowledge.

Test 2: The probability coefficients are adjusted by 10%, that is, a (−3) score is 100%, a (±2) score is 50%, a (±1) score is 20%, and a (0) score is 0%. It means that probability of the first-order action and the second-order action is changed. Certainly, because the initial questionnaire is qualitative analysis, the probability coefficient may be uniformly adjusted upwards or downwards, or a gap between different categories may be widened, to simulate a possible score of the experts in mind. In this test, different attempts may be made.

Test 3: Because focus of different transport sectors such as road, rail, air and water transport on sustainable development are inconsistent, the sectors having the experts affect the ranking of the sustainable development goals. In this test, results are divided, and knowledge of experts in sectors such as roads, rails, air, and water transportation is analyzed separately, and priority action focuses of different transport sectors under the SDG framework are compared.

Therefore, in the present disclosure, for collaboratively promoting implementation of a plurality of sustainable goals in the traffic and transportation system to the maximum extent with available resources, a foundation is laid for establishing a sustainable transport indicator system integrating transport development tasks and SDGs, revealing the interaction mechanism between transport SDGs, positioning a goal group of leverage point with most synergistic effect on the system, and designing a sustainable transport actions that maximize synergistic benefits.

According to the present disclosure, there are three main roles:

1. In the present disclosure, the SDG framework is creatively introduced to perform research on the sustainable transport. The sustainable transport indicator system obtained by extracting and combining the SDG framework with transport development tasks has localized features, and is more convenient for practice.

2. In the present disclosure, the feedback path network between the plurality of goals of the sustainable transport is deeply analyzed, the complex direction and degree of interaction between the first-order and second-order actions between the plurality of goals are quantified, the multi-goal interaction mechanism of the sustainable transport is explained. In addition, a complete feedback path between goals of the sustainable transport obtained through a comprehensive correlation between goals of the sustainable transport based on development tasks under the SDG framework, to implement the goals of the sustainable transport.

3. In the present disclosure, considering that the sustainable transport system is a system with a large quantity of human components, and is a system with natural and engineering components, a leverage point with maximum synergistic benefits is positioned based on advantages of expert knowledge and the data-driven method. Therefore, analysis is accurate and reliable, and a management method for the sustainable transport development is obtained.

The above described are merely preferred examples of the present disclosure, and are not intended to limit the present disclosure. Any modification, equivalent substitution, and improvement without departing from the spirit and principle of the present disclosure shall be included within the protection scope of the present disclosure.

1. A method for interactions between traffic and transportation systems based on a sustainable development goal SDG framework, comprising:
step 1: extending and perfecting, through a Delphi method, sustainable transport indicators under an SDG framework, wherein
a sequence of occurrence and a lexical frequency of a developmental task are analyzed through the Delphi method, the sustainable transport indicators are in a one-to-one correspondence to 17 SDGs and indicators at a next level of the SDG framework, and the sustainable transport indicators, comprising quantitative indicators and qualitative indicators, are refined and constructed;
step 2: drawing first-order gaming and synergistic effect between traffic SDGs and synergy through a typological cross-impact matrix and in combination with a panel vector autoregressive model;
step 3: parsing a multi-goal second-order interaction mechanism after probability coefficients are introduced, to determine a leverage point of a multi-goal system with maximum synergistic effect, wherein
step (1): a cross-matrix diagram is visualized;
step (2): second-order action between goals is analyzed based on probability, and a multi-goal downstream feedback path is captured; an impact path between goals is captured, first-order action and the second-order action between goals are quantified and summed, to obtain a corresponding second-order impact matrix, and a high-priority goal group is obtained by sorting; and
step (3): an empirical test is performed, and comparative analysis is performed with previous quantitative analysis; and
step 4: determining stability of the leverage point of the multi-goal system based on sensitivity analysis and sectoral analysis, wherein
three sensitivity analyses are performed to test what extent a result depends on settings of scores and probability coefficients in the multi-goal system, and a difference in sorting of priorities of sustainable development goals by different transport sectors is checked.

2. The method for interactions between traffic and transportation systems based on an SDG framework according to claim 1, wherein in step 2, the “first-order action” is defined as “direct effect of a goal A on a goal C; and if the goal A has effect on a goal B, and the goal A has effect on the goal C and a goal D, effect of the goal A on the goal C and the goal D is the second-order action, and an interaction between sustainable development goal systems are represented with knowledge of experts and stakeholders.

3. The method for interactions between traffic and transportation systems based on an SDG framework according to claim 2, wherein step 2 specifically comprises:
2.1: analyzing the quantitative indicators, wherein
within a range of the quantitative indicators, correlation is determined by performing related analysis on a non-parametric Spearman rank between goal pairs; and synergy is defined: if the goal pairs have a significant positive correlation, with a correlation coefficient greater than 0.5, and have a significant negative correlation, with a correlation coefficient less than −0.5, it is considered that there is gaming;
an interaction between goals is analyzed through the panel vector autoregressive model, wherein a formula is as follows: wherein
LnSDG_{p,t}ⁱ=β₀+β₁*LnSDG_{a,p,t-1}+β2*LnSDG_{b,p,t-1}+β₃*LnTFE_{p,t-1}+(cₚ+e_{p,t})
p represents a province, and t represents year; SDG_{p,t}ⁱ represents a score of an SDG of an i^{th} of a province p in year t; SDG_{a,p,t-1} represents a score of an SDG a in a province p with a lag of one year, SDG_{b,p,t-1} represents a score of an SDG b in the province p with a lag of one year, and TFE_{p,t-1} represents a fiscal expenditure on transport in the province p with a lag of one year; cₚ represents fixed effect between provinces; e_{p,t} represents an error term; and
an SDG a and an SDG b are goals that have a highest number of significant correlations with other goals and that are obtained based on Spearman rank correlation analysis; and
2.2: analyzing the qualitative indicators, wherein
a cross-impact matrix is constructed in a manner of scoring by experts through a questionnaire, to organize and summarize knowledge about interactions between SDGs in traffic; and through a seven-score typology that specifically describes nature of the interactions between SDGs, analysis is performed from cancellation (−3), counteraction (−2), constraint (−1), and no significant interaction (0) during a negative interaction, to advancement (+1), reinforcement (+2), and inseparability (+3) of a positive interaction.

4. The method for interactions between traffic and transportation systems based on an SDG framework according to claim 3, wherein further, in the cross-impact matrix, a sum of high rows indicates that a goal has great net positive effect on another goal, and a goal with the sum of high rows is regarded as a synergistic goal; and a list of cross-impact matrices belonging to each expert is extracted from questionnaires submitted by the experts, a score of each expert on each pair of goals is superimposed, and the list of cross-impact matrices is obtained by averaging scores of all experts;
a scoring questionnaire of the interactions is sent to the experts, attached with graphic descriptions of basic knowledge about the SDG, each score is attached with explanatory annotation, and a first round of scoring is performed; and a summary of the first round of scoring is fed back to the experts through the Delphi method, the experts are required to perform a second round of scoring, and finally, results of scoring are analyzed.

5. The method for interactions between traffic and transportation systems based on an SDG framework according to claim 1, wherein in step (1), a network analysis diagram of a system network architecture SNA is used to reflect directions and degrees of interactions between goals in pairs in a thermodynamic matrix diagram, and a network diagram that there is an interaction with another key goal is extracted for subsequent second-order analysis.

6. The method for interactions between traffic and transportation systems based on an SDG framework according to claim 2, wherein in the second step, a specific formula is as follows:
first-order impact (direct impact of A on C):
P_{AC}=probability value;
second-order impact (indirect impact of A on C through B):
P_{ABC}=P_{AB}×P_{BC}
overall impact (overall impact of A on C, comprising the first-order impact and the second-order impact); and
P_{Total}=P_{AC}+P_{ABC}
a goal (group) with a highest score, that is, the leverage point for the system, is obtained after sorting is re-performed.

7. The method for interactions between traffic and transportation systems based on an SDG framework according to claim 6, wherein
the impact of A on C comprises: 1: the direct impact of A on C (line 1); 2: impact of B on C after impact of A on B, that is, A has second-order impact on C (line 2), wherein concept of probability is introduced, to be specific, 6 scores represent 90% probability of impact, 2 scores represent 60% probability of impact, 1 score represents 30% probability of impact, and 0 scores represents 0% probability of impact;
therefore, if probability of second-order impact of A on C is 60%*(−30%)=−18% and probability of first-order impact of A on C is +90%, a sum of the second-order impact of A on C and the first-order impact of A on C is (+90%)+(−18%)=+72%.

8. The method for interactions between traffic and transportation systems based on an SDG framework according to claim 7, wherein the third step, the leverage point is in a range of the quantitative indicators, that is, there is a support by quantitative data; if there is no support by quantitative data, a corresponding quantitative indicator needs to be established, and a data source is obtained by mining a database or by discounting an intermediate coefficient; and the corresponding quantitative indicator is substituted into a panel regression model with a time-lag coefficient, to analyze an interaction between goals, and validate the leverage point by comparison.

9. The method for interactions between traffic and transportation systems based on an SDG framework according to claim 1, wherein step 4 specifically comprises the following manners:
test 1: considering settings of scores −3 to 3, when first-order impact of the cross-impact matrix is calculated, by replacing a simple summing manner of original scores, a score with a highest frequency of occurrence is taken as a score of a grid, and subsequently, scores of rows and columns of the matrix are sorted;
test 2: the probability coefficients are adjusted by 10%, that is, a (−3) score is 100%, a (±2) score is 50%, a (±1) score is 20%, and a (0) score is 0%; and
test 3: in this test, results are divided, and knowledge of experts in sectors such as roads, rails, air, and water transportation is analyzed separately, and priority action focuses of different transport sectors under the SDG framework are compared.
